(19) United States
(12) Patent Application Publication
(10) Pub. No.: US 2015/0016498 A1
(43) Pub. Date: Jan. 15, 2015

(54) CONTROL DEVICE, CONTROL METHOD AND CONTROL SYSTEM

(71) Applicant: FUJITSU LIMITED, Kawasaki-shi (JP)

(72) Inventors: Keisuke Yamasaki, Yokohama (JP); Kunihiro Kotani, Yokohama (JP)

(73) Assignee: Fujitsu Limited, Kawasaki (JP)

(21) Appl. No.: 14/304,042

(22) Filed: Jun. 13, 2014

(30) Foreign Application Priority Data
Jul. 9, 2013 (JP) 2013-143907

(51) Int. Cl. H04L 25/03

(52) U.S. Cl. CPC H04L 25/03057; H04L 25/03343
USPC 375/233

(57) ABSTRACT

A control device includes: an output circuit configured to output a first signal to a first point on a first conductive wire wired on a substrate; a reception circuit configured to receive the first signal that is transmitted through the first conductive wire, from a second point on the first conductive wire, as a second signal; and a decision circuit configured to decide a compensation value of first attenuation of a third signal that is input to a second conductive wire that is wired on the substrate and different from the first conductive wire by referring to information on second attenuation of the first signal based on a waveform of the second signal.

### CROSS-REFERENCE TO RELATED APPLICATION

This application is based upon and claims the benefit of priority from the prior Japanese Patent Application No. 2013-143907 filed on Jul. 9, 2013, the entire contents of which are incorporated herein by reference.

### FIELD

The embodiments discussed herein are related to a control device, a control method and a control system.

### BACKGROUND

A large scale integration (LSI) that is coupled to a printed circuit board reads firmware (FW) from a storage device to execute the FW, and sets amplitude and compensation value of a signal that is transmitted through a high-speed transmission path of the printed circuit board.

The related art is discussed in International Publication Pamphlet No. WO 2009/019746 and Japanese National Publication of International Patent Application No. 2010-536194.

### SUMMARY

According to one aspect of the embodiments, a control device includes: an output circuit configured to output a first signal to a first point on a first conductive wire wired on a substrate; a reception circuit configured to receive the first signal that is transmitted through the first conductive wire, from a second point on the first conductive wire, as a second signal; and a decision circuit configured to decide a compensation value of first attenuation of a third signal that is input to a second conductive wire that is wired on the substrate and different from the first conductive wire by referring to information on second attenuation of the first signal based on a waveform of the second signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a control device;

FIG. 2 illustrates an example of a hardware structure of a disk enclosure;

FIG. 3 illustrates an example of an output setting information table;

FIG. 4 illustrates an example of a functional structure of a control device;

FIG. 5 illustrates an example of a transmission-side equalizer and an example of a reception-side equalizer;

FIG. 6 illustrates an example of a transmission-side equalizer;

FIG. 7 illustrates an example of a reception-side equalizer;

FIG. 8 illustrates an example of an output setting; and

FIG. 9 illustrates an example of an output setting process.

### DESCRIPTION OF EMBODIMENTS

For example, a received waveform and an eye mask pattern which indicates a receptible range are compared by superimposing signal waveforms beforehand, and a parameter of a transmission quality is automatically adjusted. For example, while at least one of transmitter parameters and at least one of receiver parameters are adjusted, an error rate is recorded and the recorded error rate is compared with a known cable length error rate to obtain the cable length.

Amplitude or a compensation value of a signal depending on a transmission characteristic of a printed circuit board may not be set. For example, amplitude or a compensation value of a signal may not be set for each of the printed circuit boards when transmission characteristics of a plurality of printed circuit boards are different because of a different manufacturer such as a manufacturing plant, a manufacturing company, and a manufacturing country.

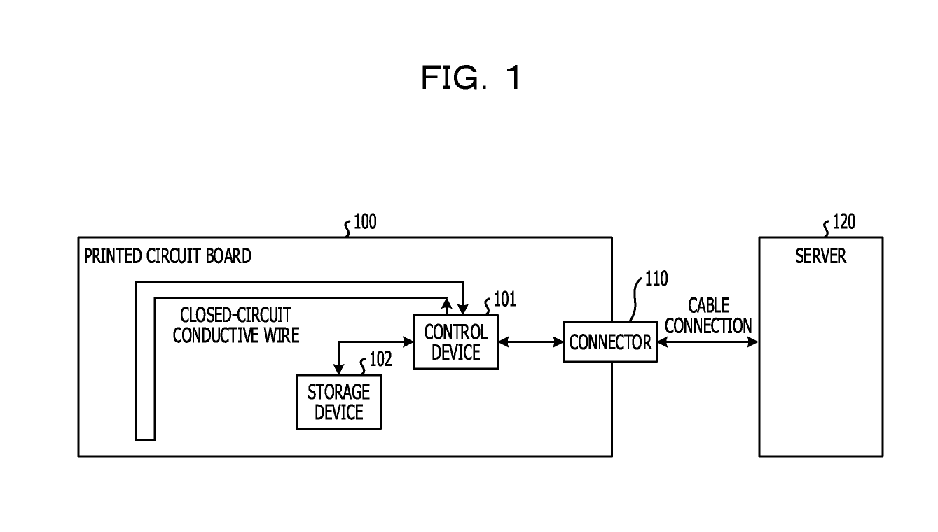

FIG. 1 illustrates an example of a control device. A control device 101 illustrated in FIG. 1 may be an electronic component that is coupled to a printed circuit board 100, and reads FW from a storage device 102 to execute the FW. The printed circuit board 100 may be, for example, an insulating substrate on which a conductive wire is wired.

A conductive wire that is used to return a signal that is input from the control device 101, to the control device 101, is wired on the printed circuit board 100. The conductive wire may be, for example, differential wiring. In the description that is made below, the conductive wire that is used to return a signal that is input from the control device 101, to the control device 101, may be referred to as “closed-circuit conductive wire”.

The control device 101 illustrated in FIG. 1 inputs a signal to the closed-circuit conductive wire, and obtains a signal that is returned from the closed-circuit conductive wire. Next, the control device 101 identifies a transmission characteristic of the conductive wire that is wired on the printed circuit board 100 based on the waveform of the signal that is input to the closed-circuit conductive wire and the waveform of the signal that is obtained from the closed-circuit conductive wire. After that, the control device 101 sets amplitude and a compensation value of the signal that is transmitted through the conductive wire that is wired on the printed circuit board 100, based on the identified transmission characteristic.

Even when the control device 101 is coupled to various printed circuit boards 100 having different transmission characteristics, the control device 101 may set amplitude and a compensation value of a signal that is transmitted through a conductive wire based on a transmission characteristic of the conductive wire that is wired on the corresponding printed circuit board 100. For example, because a difference occurs in electric permittivity and the like of the printed circuit board 100 owing that manufacturers such as a manufacturing plant and manufacturing companies are different, transmission characteristics of the various printed circuit board 100 may be different. In the description that is made below, amplitude and a compensation value may be referred to as “output setting value”.

The compensation value may be, for example, a value of amplification factor that is used for pre-emphasis or de-emphasis. The pre-emphasis may indicate, for example, compensation to uniformize amplitude of a signal after the signal is transmitted through a conductive wire in which a portion of the signal with high frequencies is easily attenuated as compared with a portion with low frequencies by amplifying beforehand the portion of the signal with high frequencies. The de-emphasis may indicates, for example, compensation to uniformize amplitude of a signal after the signal is transmitted through a conductive wire in which a portion of the signal with high frequencies is easily attenuated as compared with a portion with low frequencies by attenuating beforehand the portion of the signal with low frequencies.

When the control device 101 transmits a signal to a server 120 through a connector 110, the control device 101 may perform the transmission by controlling amplitude and a compensation value of the signal based on a transmission characteristic of the conductive wire that is wired on the printed circuit board 100.

The printed circuit board 100 to which the control device 101 is coupled may be used, for example, as an electronic component that controls an operation of a disk enclosure (DE). The DE may be, for example, a housing that houses a storage medium.

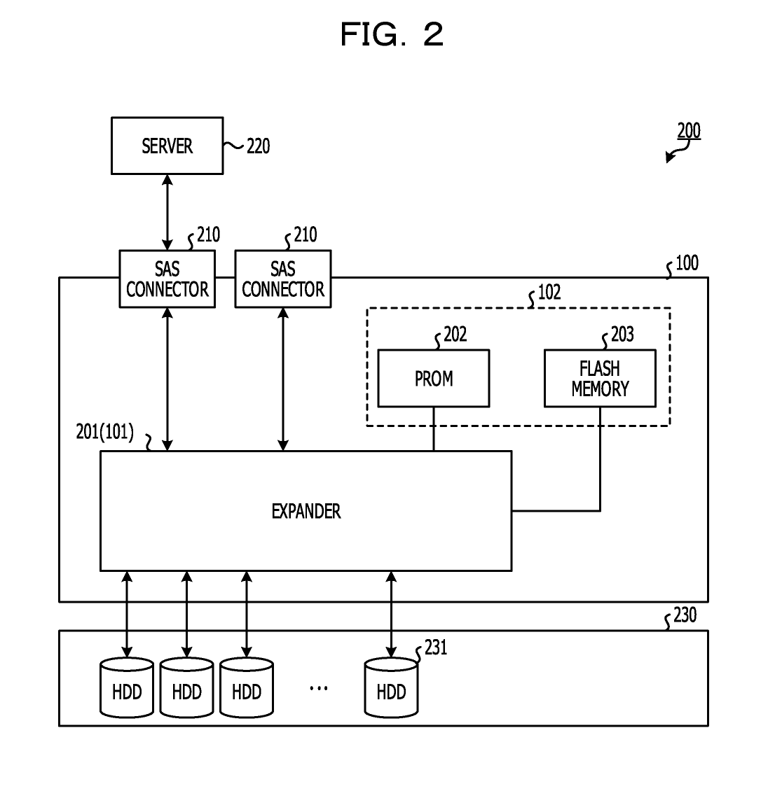

FIG. 2 illustrates an example of a hardware structure of a disk enclosure. For example, in FIG. 2, a hardware structure of a DE 200 that includes the printed circuit board 100 to which the control device 101 illustrated in FIG. 1 is coupled is illustrated. The DE 200 illustrated in FIG. 2 includes the printed circuit board 100 and a disk device 230.

The printed circuit board 100 includes an expander 201, the storage area such as a programmable ROM (PROM) 202 and a flash memory 203, and a serial attached small computer system interface (SCSI) connector (SAS connector) 210.

The expander 201 may correspond to the control device 101 illustrated in FIG. 1. The expander 201 includes a processor, a temporary memory, a transmission device, and a reception device. The expander 201 includes a plurality of ports. The processor may control the whole expander 201. The processor reads data in the storage area such as the PROM 202 and the flash memory 203, or the temporary memory by executing the FW. The processor may write data that is obtained as a result of execution of the FW, onto the storage area such as the PROM 202 and the flash memory 203, or the temporary memory.

The temporary memory includes a read only memory (ROM), a random access memory (RAM), a flash memory, or a magnetic disk drive, and may correspond to a work area of the processor.

A transmission-side equalizer corrects waveform of a signal that is transmitted to the outside of the control device 101, and transmits the corrected signal. The transmission-side equalizer may correct loss that occurs in the signal that is transmitted to the outside of the control device 101 when the signal is transmitted through the transmission path such as the conductive wire that is wired on the printed circuit board 100 before the signal is transmitted. The transmission-side equalizer may correspond to a feed forward equalizer (FFE).

The FFE may be an electronic component that corrects loss that occurs in a signal using a compensation value when the signal that has amplitude that is set as an output setting value is transmitted. The compensation value is set as an output setting value. The FFE may correct the signal using pre-emphasis, and may correct the signal using de-emphasis.

A reception-side equalizer corrects waveform of a signal that is received by the control device 101. The reception-side equalizer may correct loss that occurs in the signal that is received by the control device 101 when the signal is transmitted through the transmission path such as the conductive wire that is wired on the printed circuit board 100 after the signal is received. The reception-side equalizer may correspond to a linear equalizer (LE) and a decision feedback equalizer (DFE).

The LE automatically sets a value of gain that corresponds to amplification factor, and corrects loss that occurs in a received signal using the set gain value. The DFE automatically sets a DFE coefficient that is used for the correction, and corrects loss that occurs in the received signal using the set DFE coefficient.

The port may be a terminal that is coupled to the conductive wire that is wired on the printed circuit board 100. The port transmits and receives a signal to and from the storage area such as the PROM 202 and the flash memory 203, the SAS connector 210, or the disk device 230, through the conductive wire to which the port is coupled. The port is coupled to a closed-circuit conductive wire, and inputs a signal to the closed-circuit conductive wire, and obtains a signal that is output from the closed-circuit conductive wire.

The PROM 202 and the flash memory 203 may correspond to the storage device 102 illustrated in FIG. 1. The PROM 202 stores a boot program. The flash memory 203 is a rewritable non-volatile semiconductor memory. The SAS connector 210 may be a connector that is used to couple the printed circuit board 100 with a device such as a server 220 and a DE 200 that are provided outside the printed circuit board 100. The SAS connector 210 may be an electronic component that meets the requirements of SAS, for example. The disk device 230 may be a device that stores data that is received from the server 220. The disk device 230 may include a plurality of hard disk drives (HDDs) 231.

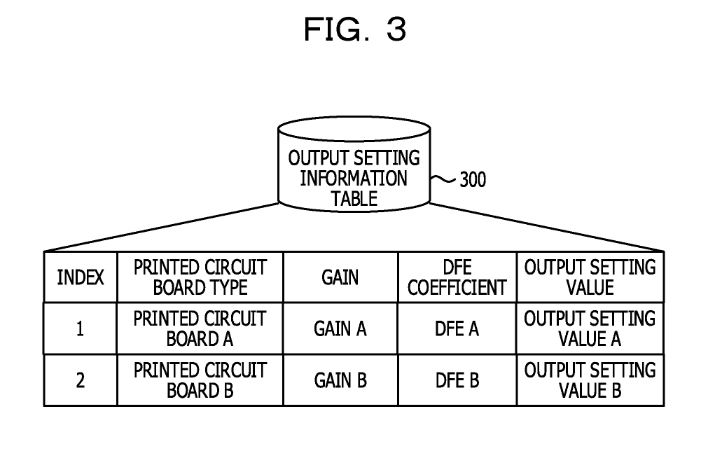

FIG. 3 illustrates an example of an output setting information table. An output setting information table 300 may correspond to, for example, the storage area such as the PROM 202 and the flash memory 203 illustrated in FIG. 2.

In FIG. 3, an example of storage content in the output setting information table 300 is illustrated. As illustrated in FIG. 3, the output setting information table 300 includes a printed circuit board type item, a gain item, a DFE coefficient item, and an output setting value item that are associated with indexes. For each of the indexes, information is set to each of the items such that records are stored.

In each of the indexes, an identification number that is used to identify each of the records is stored. In the printed circuit board type item, information that indicates the type of the printed circuit board 100 is stored. In the gain item, a range of a value of gain is stored that is automatically set by the reception-side equalizer that receives a signal through the conductive wire that is wired on the printed circuit board 100 when the printed circuit board 100 corresponds to the type that is indicated by the printed circuit board type item.

In the DFE coefficient item, a range of a value of a DFE coefficient is stored that is automatically set by the reception-side equalizer that receives the signal through the conductive wire that is wired on the printed circuit board 100 when the printed circuit board 100 corresponds to the type that is indicated by the printed circuit board type item. In the output setting value item, amplitude of the signal that is transmitted through the conductive wire that is wired on the printed circuit board 100 and a value that is set as a value of amplification factor for pre-emphasis are stored when the printed circuit board 100 corresponds to the type that is indicated by the printed circuit board type item.

For example, the record indicates output setting information that includes an identification number “1”, a name indicating the type of the printed circuit board 100 “printed circuit board A”, a range of value of gain “Gain A”, a range of a value of a DFE coefficient “DFE A”, and an output setting value “output setting value A”.

“Gain A” indicates, for example, a range of gain values “5 dB” to “10 dB”. “DFE A” indicates, for example, a range of DFE coefficient values “−1.0” to “1.0”. “Output setting value A” indicates, for example, signal amplitude “1000 mV” or an amplification factor value for pre-emphasis “1.0 dB”, as the output setting value.

In FIG. 3, the output setting information table 300 includes the gain item and the DFE coefficient item. For example, the output setting information table 300 may not include one of the gain item and the DFE coefficient item.

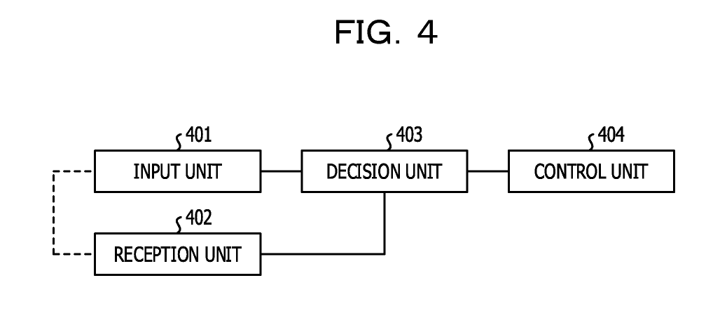

FIG. 4 illustrates an example of a functional structure of a control device. The control device illustrated in FIG. 4 may correspond to the control device 101 illustrated in FIG. 1. The control device 101 illustrated in FIG. 4 includes an input unit 401, a reception unit 402, a decision unit 403, and a control unit 404.

Functions of the input unit 401, the reception unit 402, the decision unit 403, and the control unit 404 may be achieved, for example, when programs that are stored in the storage device 102 such as the PROM 202 and the flash memory 203 illustrated in FIG. 2 are executed by the processor that is included in the expander 201 illustrated in FIG. 2.

The input unit 401 inputs a signal to a first point on the conductive wire that is wired on the substrate. The input unit 401 inputs the signal through, for example, a port that is coupled to the differential wiring that is wired on the printed circuit board 100. The conductive wire may be, for example, a closed-circuit conductive wire. The reception unit 402 receives a signal that is transmitted through the conductive wire on the printed circuit board 100.

The reception unit 402 receives a signal that is input to the first point by the input unit 401, transmitted through the conductive wire, and output through a second point on the conductive wire. The reception unit 402 receives, for example, from the port, a signal that is input by the input unit 401 and transmitted through the conductive wire. Therefore, the decision unit 403 may obtain information on attenuation of the signal that is received by the reception unit 402 based on the signal. The received signal is stored, for example, in the storage device 102 such as the PROM 202 and the flash memory 203 illustrated in FIG. 2.

The decision unit 403 may decide a compensation value of attenuation of a signal that is input to a further conductive wire that is wired on the substrate, which is different from the conductive wire, by referring to the information on attenuation of the signal based on the waveform of the signal that is transmitted through the conductive wire and is received by the reception unit 402. The decision unit 403 may decide amplitude of the signal that is input to the further conductive wire that is wired on the substrate, which is different from the conductive wire, by referring to the information on attenuation of the signal based on the waveform of the signal that is transmitted through the conductive wire and is received by the reception unit 402.

The decision unit 403 decides a combination of amplitude and a compensation value that are associated with the information on the attenuation of the signal based on the waveform of the signal that is transmitted through the conductive wire and is received by the reception unit 402, for example, by referring to correspondence information. The correspondence information may be information in which information on attenuation is associated with a combination of a compensation value of the attenuation and amplitude of a signal that is input to the further conductive wire. The correspondence information may be, for example, the output setting information table 300 illustrated in FIG. 3.

For example, in the reception-side equalizer, the decision unit 403 obtains gain that is automatically set by the LE when the received signal is corrected using the LE, and a DFE coefficient that is automatically set by the DFE when the corrected signal is corrected using the DFE. The decision unit 403 decides a combination of amplitude and a compensation value from an output setting value that corresponds to the obtained gain and DFE coefficient by referring to the output setting information table 300. The decision result may be stored, for example, in the storage device 102 such as the PROM 202 and the flash memory 203 illustrated in FIG. 2.

The control unit 404 sets amplitude of a signal that is transmitted from the port, and compensates the signal that is transmitted from the port using the amplitude and compensation value that are decided by the decision unit 403. Therefore, the control unit 404 may set values of amplitude and amplification factor for pre-emphasis or de-emphasis of a signal that is to be transmitted through the conductive wire depending on a transmission characteristic of the conductive wire that is wired on the printed circuit board 100.

The control unit 404 may output an error message and stop an operation of the control device 101 when amplitude and a compensation value are not determined by the decision unit 403. Therefore, in the control unit 404, it may be reduced that a signal that is compensated through wrong amplitude or a wrong compensation value is output from the control device 101.

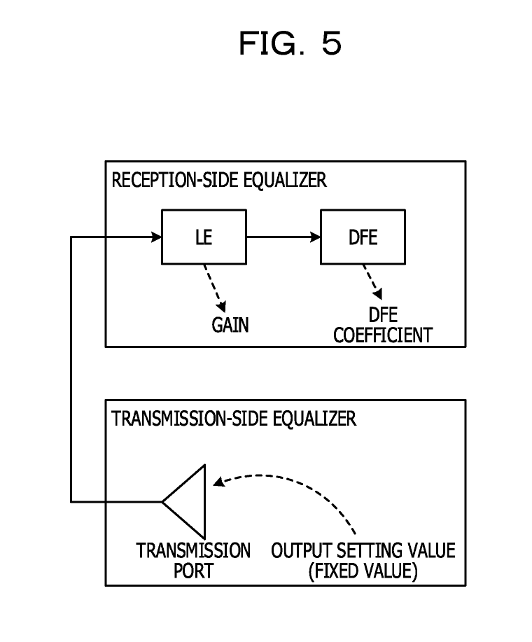

FIG. 5 illustrates an example of a transmission-side equalizer and an example of a reception-side equalizer. The transmission-side equalizer and the reception-side equalizer illustrated in FIG. 5 may be included in the control device 101 illustrated in FIG. 1. As illustrated in FIG. 5, the transmission-side equalizer sets a certain fixed value as an output setting value, and inputs a signal to the closed-circuit conductive wire through the port that is coupled to the closed-circuit conductive wire. The signal is transmitted through the closed-circuit conductive wire and received by the reception-side equalizer.

The reception-side equalizer linearly amplifies a high-frequency component using the LE to correct the signal waveform. The reception-side equalizer performs feedback of a determination result that is obtained by determining whether a digital value of a previous signal indicates 0 or 1 using the DFE to correct the signal waveform.

The LE automatically sets a value of gain that corresponds to amplification factor of the signal, and corrects loss that occurs in the received signal using the set gain value. The DFE automatically sets a DFE coefficient that is used to correct the signal, and corrects loss that occurs in the received signal using the set DFE coefficient.

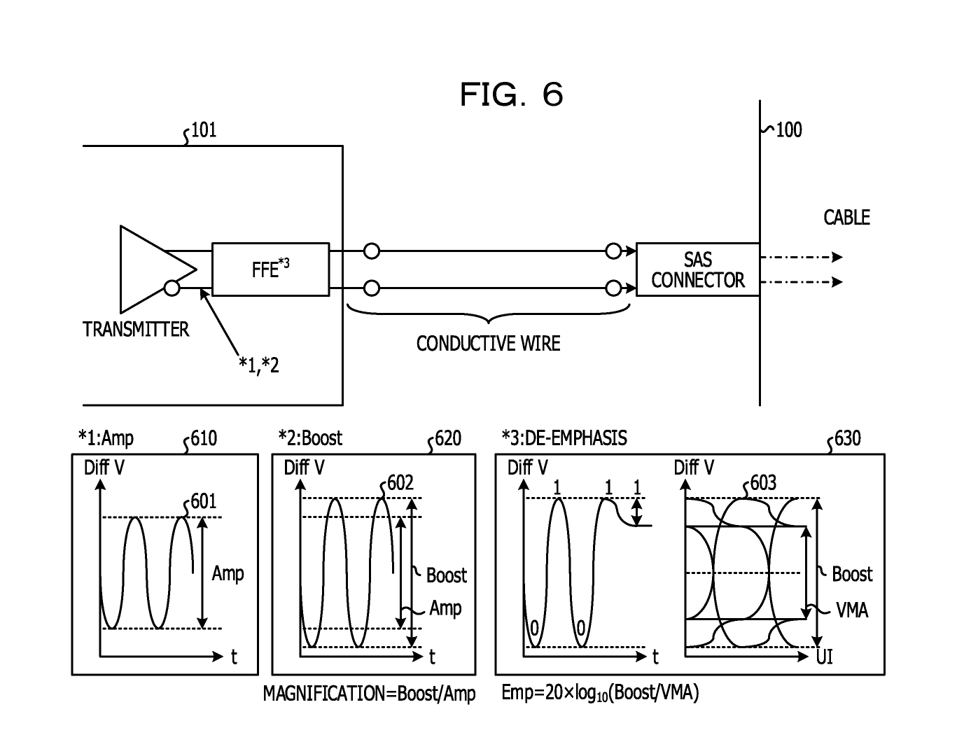

FIG. 6 illustrates an example of transmission-side equalizer. The transmission-side equalizer illustrated in FIG. 6 amplifies, for example, a signal 601 of amplitude (Amp) that is illustrated in a symbol 610 using a transmitter, to a signal 602 of amplitude (Boost) that is illustrated in a symbol 620 at a section of *1 and *2.

As illustrated in a symbol 630, the transmission-side equalizer compensates the signal 602 with an amplification factor “4 dB” by de-emphasis at a section of *3 using the FFE, and inputs the compensated signal 603 through the port to the conductive wire that is wired on the printed circuit board 100.

The FFE compensates the signal 602 with the amplification factor “4 dB” to reduce amplitude of a portion having “1” in the signal 602, for example, a portion having a low frequency in the signal 602 and changes the signal 602 to signal 603. The FFE reduces the amplitude of the portion having a low frequency in the signal 602, for example, so as to satisfy a relationship in the following equation (1).

Emp=20×log₁₀ (Boost/VMA) (1)

Here, “Emp” is a value of amplification factor. “Boost” is amplitude of a signal before compensation. “VMA” is amplitude of a signal after the compensation.

The FFE may uniformize amplitude of the signal 603 after transmission because the amplitude is reduced in the portion having a low frequency similar to the portion having a high frequency when the portion having a high frequency in the signal 602 is attenuated by transmitting the signal through the conductive wire that is wired on the printed circuit board 100.

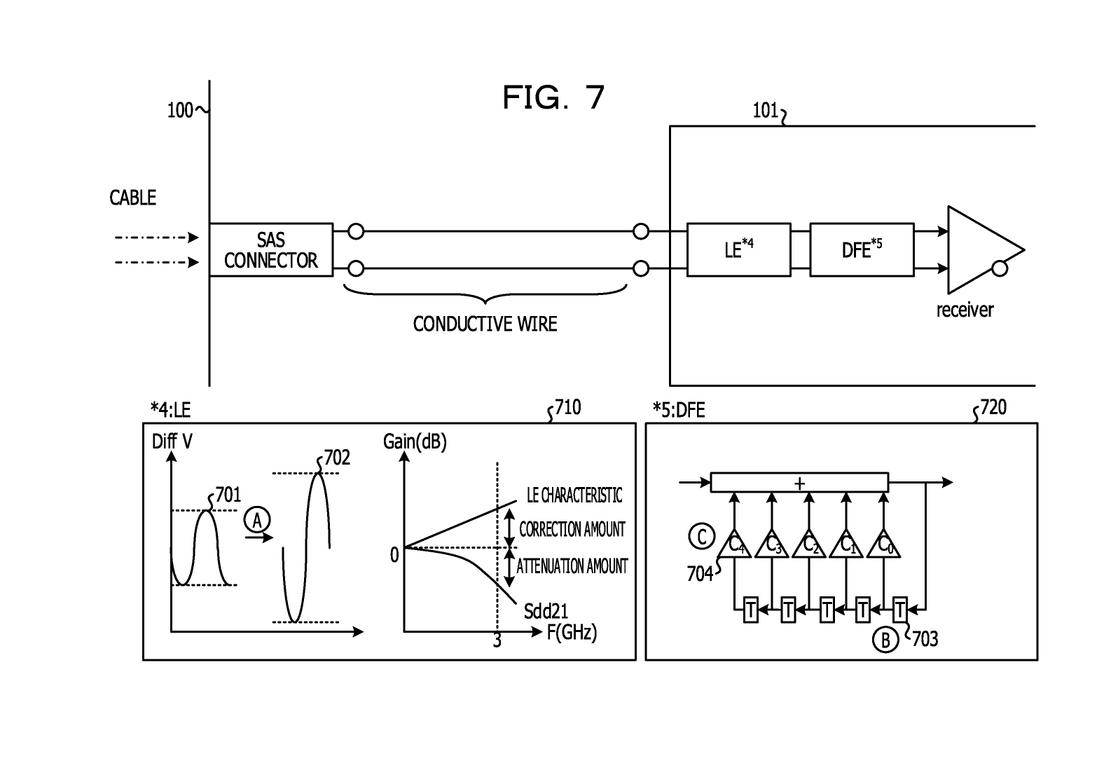

FIG. 7 illustrates an example of a reception-side equalizer. The reception-side equalizer illustrated in FIG. 7 receives, from the port, the signal 701 that is output from the conductive wire that is wired on the printed circuit board 100. As illustrated in a symbol 710, the reception-side equalizer automatically sets gain and corrects the received signal 701 to change the signal 701 to the signal 702 using the LE in a section of *4.

The LE automatically sets a value of gain that corresponds to amplification factor and corrects loss that occurs in the received signal 701 using the set gain value. For example, the LE automatically sets the gain to match an attenuation amount Sdd21 of a signal of 3 GHz and a correction amount Gain substantially, corrects the loss that occurs in the received signal 701, and change the signal 701 to the signal 702. For example, in \textcircled{A}, the waveform that is attenuated through the insertion loss (Sdd21) of the transmission path is corrected by the LE so as to satisfy “attenuated portion of Sdd21+corrected portion of the LE=0”.

As illustrated in a symbol 720, the reception-side equalizer automatically sets a DFE coefficient and further corrects the signal 702 using the DFE in a portion of *5. The received signal is corrected by performing feedback of the previous waveform. The DFE performs the feedback to delay the signal 702 by τ using a circuit 703. In \textcircled{B}, the waveform is delayed by τ at each stage. By multiplying DFE coefficients Cn, for example, n=0, 1, to 4, in FIG. 7 using a circuit 704 and adding the multiplied results to the signal 702, loss that occurs in the signal 702 is corrected. In \textcircled{C}, the number of taps indicates the number of stages at which feedback of the previous waveform is performed. The DEF coefficient C may be decided by least squares method (LSM).

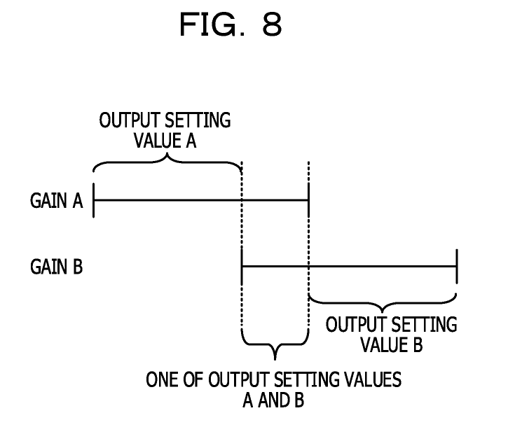

FIG. 8 illustrates an example of an output setting. For the sake of simplicity of explanation, in FIG. 8, an output setting value is decided using a value of gain. The output setting value may be decided using a combination of values of gain and DFE coefficient.

As illustrated in FIG. 8, the control device 101 obtains an output setting value A and sets the obtained value to the transmission-side equalizer when the value of gain that is automatically set by the reception-side equalizer is included in a range of the gain A in the output setting information table 300.

The control device 101 obtains an output setting value B and sets the obtained value to the transmission-side equalizer when the value of gain that is automatically set by the reception-side equalizer is included in a range of gain B in the output setting information table 300.

The control device 101 obtains one of the output setting value A and the output setting value B when the value of gain that is automatically set by the reception-side equalizer is included in an overlapping range between the ranges of the gain A and the gain B in the output setting information table 300. The control device 101 sets the obtained one of the output setting value A and the output setting value B to the transmission-side equalizer.

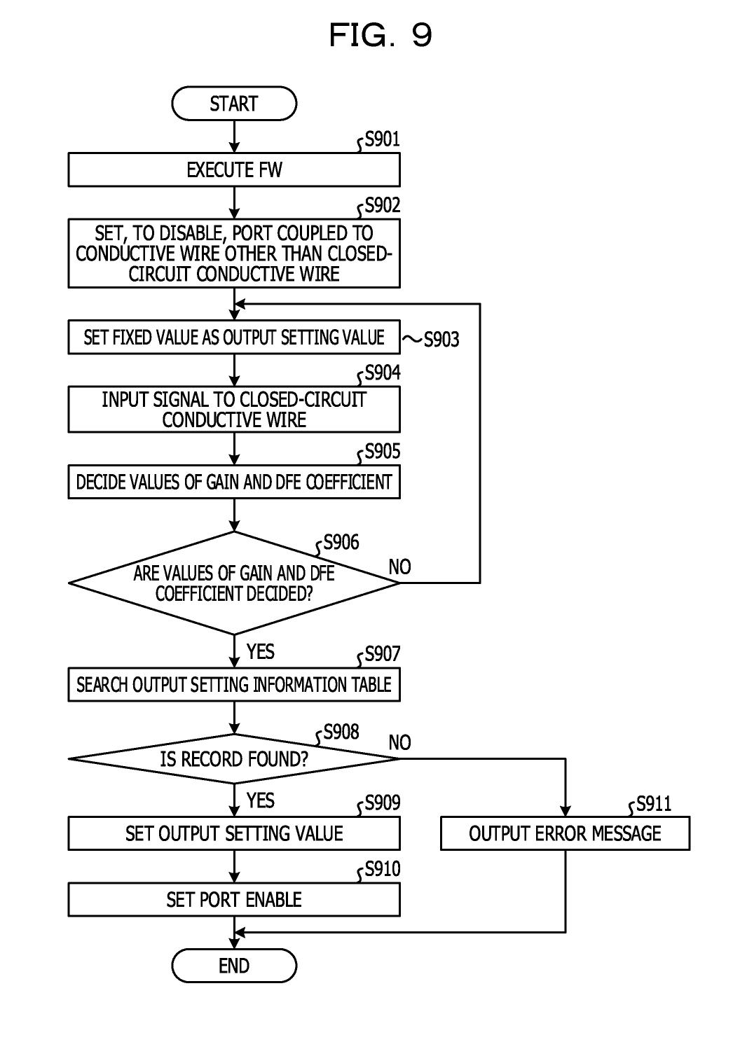

FIG. 9 illustrates an example of an output setting process. The output setting process illustrated in FIG. 9 may be executed by the control device 101 illustrated in FIG. 1. When power is applied to the control device 101 illustrated in FIG. 9, the control device 101 reads FW and executes the FW (Operation S901). The control device 101 sets, to disable, a port that is coupled to a conductive wire other than a closed-circuit conductive wire after executing the FW (Operation S902).

The control device 101 causes the transmission-side equalizer to set a fixed value as an output setting value (Operation S903). The transmission-side equalizer inputs a signal to the closed-circuit conductive wire (Operation S904). The reception-side equalizer decides a value of gain and a value of a DFE coefficient (Operation S905).

The control device 101 determines whether or not the reception-side equalizer performs the decision (Operation S906). When the decision is not performed (No in Operation S906), the processing returns to Operation S903. When the decision is performed (Yes in Operation S906), the control device 101 searches, from the output setting information table 300, for a record that indicates a range that includes the value of the gain and the value of the DFE coefficient that are decided (Operation S907).

The control device 101 determines whether or not the record is found (Operation S908). When the record is found (Yes in Operation S908), the control device 101 sets an output setting value of the found record to the transmission-side equalizer (Operation S909). The control device 101 sets the port enable (Operation S910). The output setting process by the control device 101 ends.

When the record is not found (No in Operation S908), the control device 101 outputs an error message (Operation S911). The output setting ends. The control device 101 sets a value of amplification factor for pre-emphasis and amplitude of a signal that is transmitted through the conductive wire depending on a transmission characteristic of the conductive wire that is wired on the printed circuit board 100.

The control device 101 may identify a transmission characteristic of the conductive wire that is wired on the printed circuit board 100 based on the waveform of the signal that is input to the closed-circuit conductive wire and the waveform of the signal that is obtained from the closed-circuit conductive wire. The control device 101 may set amplitude and a compensation value of a signal that is transmitted through the conductive wire that is wired on the printed circuit board 100 based on the identified transmission characteristic. Even when the control device 101 is coupled to the various printed circuit boards 100 having different transmission characteristics, the control device 101 may set amplitude and a compensation value of a signal that is transmitted through a conductive wire that is wired on the corresponding printed circuit board 100 depending on a transmission characteristic of the conductive wire.

In the control device 101, amplitude and a compensation value of a signal that is transmitted through the conductive wire that is wired on the printed circuit board 100 may be set by referring to the output setting information table 300. Even when the control device 101 is coupled to the various printed circuit boards 100 having different transmission characteristics, the control device 101 may set amplitude and a compensation value of a signal that is transmitted through a conductive wire that is wired on the corresponding printed circuit board 100 depending on a transmission characteristic of the conductive wire. The control device 101 may set amplitude and a compensation value of the signal that is transmitted through the conductive wire at high speed.

Printed circuit boards 100 each having a different transmission characteristic are separately inspected, and a transmission characteristic of a conductive wire that is wired on the corresponding printed circuit board 100 is identified, and amplitude and a compensation value of a signal may be set depending on the transmission characteristic. In this case, due to the inspection of the individual printed circuit boards 100, manufacturing cost and a manufacturing time period may be increased. Because the control device 101 automatically sets amplitude and a compensation value of a signal depending on a transmission characteristic of the conductive wire that is wired on the printed circuit board 100, and the printed circuit boards 100 do not have to be individually inspected, manufacturing cost and a manufacturing time period may be reduced.

The control device 101 may automatically set amplitude and a compensation value of a signal depending on a transmission characteristic of the conductive wire that is wired on the printed circuit board 100 even when the printed circuit board 100 is aged or there is manufacturing variation of the printed circuit boards 100. Therefore, occurrence of an operation error may be reduced even when the printed circuit board 100 is aged or there is manufacturing variation of the printed circuit boards 100.

In the control device 101, amplitude and a compensation value of a signal may be automatically set depending on a transmission characteristic of the conductive wire that is wired on the printed circuit board 100. Therefore, because the printed circuit board 100 may not be inspected, manufacturing cost and a manufacturing time period may be reduced. In the control device 101, when amplitude and a compensation value of a signal depending on a transmission characteristic of the conductive wire on the printed circuit board 100 is not set, an error message is output, and the operation may be terminated. Therefore, occurrence of the operation error may be reduced.

The above-described control method may be executed by causing a computer such as a personal computer and a workstation to execute a program that is prepared beforehand. The program is recorded to a computer-readable recording medium such as a hardware disk, a flexible disk, a CD-ROM, an MO, and a DVD, read from the recording medium and be executed by a computer. A control program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device comprising:
an output circuit configured to output a first signal to a first point on a first conductive wire wired on a substrate;
a reception circuit configured to receive the first signal that is transmitted through the first conductive wire, from a second point on the first conductive wire, as a second signal; and
a decision circuit configured to decide a compensation value of first attenuation of a third signal that is input to a second conductive wire that is wired on the substrate and different from the first conductive wire by referring to information on second attenuation of the first signal based on a waveform of the second signal.

2. The control device according to claim 1, wherein
the decision circuit configured to decide a first amplitude of the third signal by referring to the information on the second attenuation.

3. The control device according to claim 1, wherein
the decision circuit configured to decide a combination of a first amplitude of the third signal and the compensation value of the first attenuation by referring to correspondence information in which the information on the second attenuation and the combination of the first amplitude and the compensation value of the first attenuation.

4. The control device according to claim 1, wherein
the output circuit includes:
a transmitter configured to amplify a signal; and
a first equalizer configured to compensate an amplified signal and output a compensated signal to the first point as the first signal.

5. The control device according to claim 1, wherein
the reception circuit includes:
a second equalizer configured to correct the second signal with an amplification factor; and
a third equalizer configured to correct an output signal of the second equalizer with an equalization coefficient.

6. The control device according to claim 5, wherein
the decision circuit configured to decide the compensation value based on the amplification factor.

7. A control method comprising:
outputting a first signal to a first point on a first conductive wire that is wired on a substrate;
receiving the first signal that is transmitted through the first conductive wire, from a second point on the first conductive wire, as a second signal;
referring, by a computer, to information on second attenuation of the first signal based on a waveform of the second signal; and
deciding a compensation value of first attenuation of a third signal that is input to a second conductive wire that is wired on the substrate and different from the first conductive wire.

8. The control method according to claim 7, comprising:
deciding a first amplitude of the third signal by referring to the information on the second attenuation.

9. The control method according to claim 7, comprising:
deciding a combination of a first amplitude of the third signal and the compensation value of the first attenuation by referring to correspondence information in which the information on the second attenuation and the combination of the first amplitude and the compensation value of the first attenuation.

10. The control method according to claim 7, comprising:
amplifying a signal by a transmitter; and
compensating, by a first equalizer, an amplified signal; and
outputting a compensated signal to the first point as the first signal.

11. The control method according to claim 7, comprising:
correcting the second signal with an amplification factor by a second equalizer; and
correcting an output signal of the second equalizer with an equalization coefficient by a third equalizer.

12. The control method according to claim 11, comprising:
deciding the compensation value based on the amplification factor.

13. A control system comprising:
a memory configured to store a program; and
a processor configured to execute the program so as to perform operations to:
output a first signal to a first point on a first conductive wire that is wired on a substrate;
receive the first signal that is transmitted through the first conductive wire, from a second point on the first conductive wire, as a second signal;
refer, by a computer, to information on second attenuation of the first signal based on a waveform of the second signal; and
decide a compensation value of first attenuation of a third signal that is input to a second conductive wire that is wired on the substrate and different from the first conductive wire.

14. The control system according to claim 13, wherein the operations include deciding a first amplitude of the third signal by referring to the information on the second attenuation.

15. The control system according to claim 13, wherein the operations include deciding a combination of a first amplitude of the third signal and the compensation value of the first attenuation by referring to correspondence information in which the information on the second attenuation and the combination of the first amplitude and the compensation value of the first attenuation.

16. The control system according to claim 13, comprising:
a transmitter configured to amplify a signal; and
a first equalizer configured to compensate an amplified signal and output a compensated signal to the first point as the first signal.

17. The control system according to claim 16, comprising:
a second equalizer configured to correct the second signal with an amplification factor; and
a third equalizer configured to correct an output signal of the second equalizer with an equalization coefficient.

18. The control system according to claim 13, wherein the operations include deciding the compensation value based on the amplification factor.
